(19) United States
(12) Patent Application Publication
(10) Pub. No.: US 2024/0375351 A1
(43) Pub. Date: Nov. 14, 2024

(54) SHAPING DEVICE, SHAPING METHOD, AND LIQUID EJECTION DEVICE

(71) Applicant: MIMAKI ENGINEERING CO., LTD., Nagano (JP)

(72) Inventor: Masayuki Furuse, Nagano (JP)

(73) Assignee: MIMAKI ENGINEERING CO., LTD., Nagano (JP)

(21) Appl. No.: 18/690,254

(22) PCT Filed: Sep. 20, 2022
(86) PCT No.: PCT/JP2022/034902

§ 371 Date: Mar. 7, 2024

(30) Foreign Application Priority Data
Sep. 21, 2021 (JP) 2021-152977
Sep. 5, 2022 (JP) 2022-141040

(51) Int. Cl. B29C 64/194; B29C 64/232; B29C 64/236; B29C 64/241; B33Y 10/00; B33Y 30/00

(52) U.S. Cl. CPC B29C 64/194; B29C 64/232; B29C 64/236; B29C 64/241; B33Y 10/00; B33Y 30/00

(57) ABSTRACT

Shaping of a shaped object is appropriately performed with high accuracy. A shaping device that shapes a shaped object includes head units that are ejection heads, a carriage that holds the head units, a main scan driving part, and a flattening roller unit that is a flattening member having a flattening roller, in which the main scan driving part includes a guide member that guides movement of the carriage in a main scanning direction, and a drive mechanism that moves the carriage along the guide member, and the flattening roller unit is coupled to the carriage so as to be held by the guide member movably in the main scanning direction outside the carriage and move together with the carriage in main scan operation.

### TECHNICAL FIELD

This invention relates to a shaping device, a shaping method, a liquid ejection device, and a liquid ejection method.

### BACKGROUND ART

Conventionally, a liquid ejection device such as a shaping device (3D printer) that shapes a shaped object is known (see, for example, Patent Literature 1). Such a shaping device shapes a shaped object by a layered shaping method by layering a plurality of layers of a shaping material formed by an ejection head such as an inkjet head.

### CITATION LIST

### Patent Literature

Patent Literature 1: Japanese Unexamined Patent Publication No. 2015-071282

### SUMMARY OF INVENTION

### Technical Problems

When the shaping device shapes a shaped object by layering the shaping material, it is preferable to perform flattening of each layer with a flattening roller. In this case, performing shaping with high quality usually requires performing adjustment of the height of the flattening roller. Therefore, a configuration that facilitates adjustment of the height of the flattening roller has been conventionally desired. Therefore, an object of this invention is to provide a shaping device, a shaping method, a liquid ejection device, and a liquid ejection method that can solve the above problem.

### Solutions to Problems

The inventor of this application conducted intensive research on a configuration for facilitating adjustment of the height of the flattening roller. Then, the inventor has conceived of disposing the flattening roller outside a carriage holding an ejection head. When shaping a shaped object by layering a shaping material, it is conceivable of, for example, holding, with the carriage, the ejection head that ejects the shaping material, and performing shaping of the shaped object while moving the carriage. In this case, flattening of the layer is usually performed during an operation of forming a layer of shaping by holding the flattening roller together with the ejection head by the carriage. On the other hand, the inventor of this application has found that intentionally disposing the flattening roller outside the carriage facilitates adjustment of the height of the flattening roller. In this case, the presence of the flattening roller outside the carriage allows adjustment of the height of the flattening roller to be performed while suppressing an influence on adjustment of inclination of the carriage. This can increase the degree of freedom of adjustment on the flattening roller, enabling the height adjustment to be performed with higher accuracy.

The inventor of this application has further conceived of not simply disposing the flattening roller outside the carriage but movably holding a flattening member (e.g., a flattening roller unit) having a flattening roller independently of the carriage using a guide member that guides movement of the carriage. This configuration can appropriately prevent a bend from occurring in the guide member. The inventor of this application has further conceived of coupling the carriage and the flattening member while holding the flattening member independently of the carriage by the guide member. This configuration can appropriately move the flattening member together with the carriage when the carriage moves. This can appropriately execute a flattening operation by the flattening member with the flattening member being disposed outside the carriage.

The inventor of this application has found features necessary for obtaining such effects through further intensive research, and has reached this invention. In order to solve the above problem, this invention is a shaping device that shapes a shaped object by layering layers formed of a shaping material, the shaping device including: an ejection head, configured to eject the shaping material; a carriage, configured to hold the ejection head; a main scan driving part, configured to cause the ejection head to perform a main scan operation of ejecting the shaping material while moving in a main scanning direction set in advance; and a flattening member having a flattening roller, configured to flatten a layer formed of the shaping material, in which the main scan driving part includes: a guide member, configured to guide a movement of the carriage in the main scanning direction, and a drive mechanism, configured to move the carriage along the guide member. The flattening member is held by the guide member movably in the main scanning direction outside the carriage, and is coupled to the carriage so as to move together with the carriage in the main scan operation.

This configuration enables, by disposing the flattening member outside the carriage, adjustment of the height of the flattening roller of the flattening member to be appropriately performed with high accuracy. Due to the flattening member being movably held by the guide member outside the carriage and the flattening member being coupled to the carriage, it is possible to appropriately execute the flattening operation by the flattening roller with the flattening roller being disposed outside the carriage. Therefore, this configuration can appropriately perform shaping of a shaped object with high accuracy. In this case, by disposing the flattening member outside the carriage that holds the ejection head, it becomes also possible to achieve reduction in size and weight of the carriage.

In this configuration, as the guide member, for example, a guide rail, which is a rail-shaped guide member, or the like can be suitably used. It is conceivable of bringing coupling between the flattening member and the carriage not into a state where the positional relationship between the both is fully fixed but into a state where the both are connected to each other with a certain degree of looseness. In this case, it is conceivable that the flattening member moves together with the carriage by moving the carriage along the guide member, and the both are coupled in a state where fine adjustment such as inclination or height of one of the carriage and the flattening member can be performed without moving the other. More specifically, the flattening member is coupled to the carriage so that the position of the flattening roller in a vertical direction can be adjusted without changing the inclination of the carriage with respect to a horizontal direction. This configuration can appropriately perform adjustment of the height of the flattening roller without affecting the inclination of the carriage. This can more appropriately adjust the height of the flattening roller with a high degree of freedom. In this case, it is preferable that the flattening member be further coupled to the carriage so that the inclination of the carriage with respect to the horizontal direction can be adjusted without changing the position of the flattening roller in the vertical direction. This configuration can appropriately perform adjustment of inclination of the carriage without affecting the height of the flattening roller. In this configuration, the flattening member is coupled to the carriage by being connected by, for example, attraction force of a magnet. This configuration can appropriately couple the carriage and the flattening member in a state where the above adjustment can be appropriately performed.

In this configuration, the drive mechanism includes, for example, a belt member having an annular shape stretched along a moving range of the carriage in the main scanning direction, and the drive mechanism is configured to move the carriage in the main scanning direction by rotationally moving the belt member. In this case, the flattening member is configured to move in the main scan operation together with the carriage by not being directly connected to the belt member, being held by the guide member movably in the main scanning direction, and being coupled to the carriage. This configuration can appropriately move the flattening member together with the carriage at the time of the main scan operation.

In this configuration, the flattening member includes: a rotation motor, configured to generate a driving force for rotating the flattening roller, for example. This configuration can appropriately flatten the layer of the shaping material with the flattening roller. The flattening member may further include a roller moving motor, configured to generate a driving force for moving the flattening roller in the vertical direction. This configuration can easily and appropriately change the position of the flattening roller in the vertical direction. In this case, it is conceivable that, the weight of the flattening member becomes heavy as the flattening member includes the plurality of motors. Therefore, for example, when the flattening roller is disposed in the carriage, a problem of weight increase of the configuration held by the carriage easily occurs. In this case, the weight concentrates on the position where the guide member holds the carriage, whereby bend of the guide member easily occurs. On the other hand, when the flattening member is disposed outside the carriage, the occurrence of such problem can be appropriately prevented.

The flattening member is disposed only on one side in the main scanning direction with respect to the ejection head. In this case, for example, when the flattening roller is disposed in the carriage, a difference occurs in weight between one side and the other side in the main scanning direction, and inclination of the carriage where the side provided with the flattening roller of the carriage is lowered may easily occur. Therefore, in this configuration, the flattening member is disposed outside the carriage only on one side in the main scanning direction with respect to the carriage. This configuration can more appropriately prevent inclination from occurring in the carriage due to the weight of the flattening member.

The features of this invention can also be considered as features of an invention of a shaping method of shaping a shaped object with the shaping device having the above configuration. Also in this case, a similar effect to that described above can be obtained. In this case, the shaping method can also be considered as a manufacturing method of the shaped object.

Furthermore, the features of the invention of this application can also be considered as features of the configuration of a device other than the shaping device. It is also conceivable of coupling a member having a function different from that of the flattening member to the carriage for the ejection head. In this case, it can be considered that an effect similar to at least a part of the above effect can be obtained by such configuration. Regarding the configuration of this invention, it is conceivable a liquid ejection device that ejects a liquid, the liquid ejection device including: an ejection head, configured to eject the liquid; a carriage, configured to hold the ejection head; a main scan driving part, configured to cause the ejection head to perform a main scan operation of ejecting the liquid while moving in a main scanning direction set in advance; and a function member that is a member having a predetermined function different from a function of the ejection head, in which the function member is coupled to the carriage so as to move together with the carriage in the main scan operation outside the carriage. This configuration can achieve reduction in size and weight of the carriage. It is possible to appropriately move the function member together with the carriage at the time of the main scan operation with the function member being disposed outside the carriage for the ejection head. The features of the invention of this application can also be considered as features of a liquid ejection method corresponding to such configuration.

### Effect of the Invention

According to this invention, shaping of a shaped object can be appropriately performed with high accuracy.

### BRIEF DESCRIPTION OF THE DRAWINGS

FIG. 1 is a view describing a shaping device 10 according to an embodiment of this invention. (a) of FIG. 1 illustrates an example of a configuration of a main part of the shaping device 10. (b) of FIG. 1 illustrates an example of a configuration of a head part 12 of the shaping device 10.

FIG. 2 is a view illustrating an example of a more specific configuration of the head part 12. (a) and (b) of FIG. 2 illustrate an example of a specific configuration of the head part 12.

FIG. 3 is a view illustrating an example of a configuration of a shaped object 50 shaped by the shaping device 10.

FIG. 4 is a view describing a main scan driving part 18 and the head part 12 in more detail.

FIG. 5 is a view describing a liquid ejection device 100 different from the shaping device. (a) of FIG. 5 illustrates an example of a configuration of the liquid ejection device 100. (b) of FIG. 5 illustrates an example of a configuration of the head part 12 of the liquid ejection device 100.

### DESCRIPTION OF EMBODIMENTS

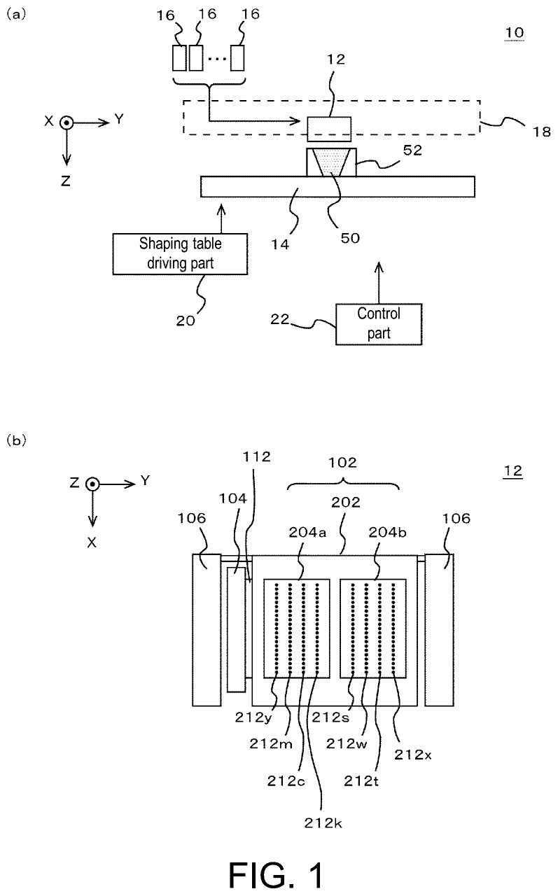

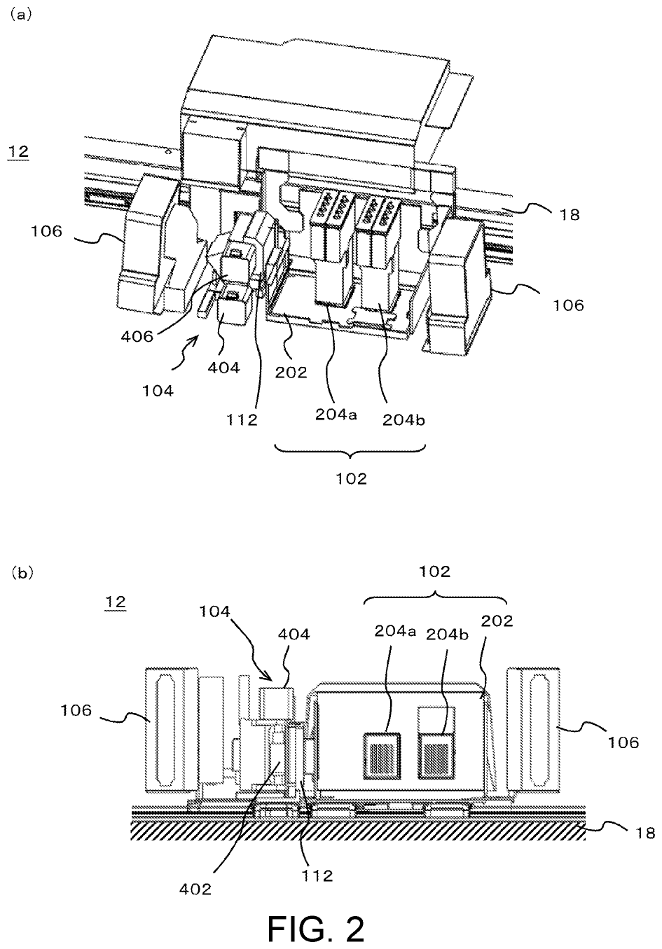

An embodiment according to this invention will be described below with reference to the drawings. FIGS. 1 and 2 are views describing the shaping device 10 according to an embodiment of this invention. (a) of FIG. 1 illustrates an example of the configuration of a main part of the shaping device 10. (b) of FIG. 1 illustrates an example of the configuration of the head part 12 of the shaping device 10. FIG. 2 illustrates an example of a more specific configuration of the head part 12. (a) and (b) of FIG. 2 are a partially exploded perspective view and a bottom view illustrating an example of a specific configuration of the head part 12 together with a part of the main scan driving part 18 of the shaping device 10.

The shaping device 10 of this example is a device (3D printer) that shapes a three-dimensional shaped object by a layered shaping method, and shapes the shaped object 50, at least a part of which is colored, by using ink as a shaping material and forming layers of ink in a layering manner. The shaping device 10 of this example is an example of a liquid ejection device that ejects liquid. The shaped object 50 can be considered as a three-dimensional structural object. The shaping device 10 of this example is a full-color shaping device that can shape a shaped object colored in full color, and executes the operation of shaping of the shaped object 50 based on shaped object data, which is data indicating the shaped object that is to be shaped. In this case, the shaping device 10 receives the shaped object data from a computer (control PC) that controls the operation of the shaping device 10, for example.

As illustrated in the figure, the shaping device 10 of this example includes the head part 12, a shaping table 14, a plurality of ink tanks 16, the main scan driving part 18, a shaping table driving part 20, and a control part 22. Except for the points described below, the shaping device 10 may have a configuration identical or similar to that of a known shaping device. More specifically, except for the points described below, the shaping device 10 may have features identical or similar to those of a known shaping device that performs shaping by ejecting, by an inkjet method, ink that becomes a shaping material. The shaping device 10 may further include various configurations necessary for shaping and the like of the shaped object 50 other than the illustrated configuration.

The head part 12 is configured to eject the material of the shaped object 50. In this example, as described above, ink is used as the material of the shaped object 50. The ink can be considered a functional liquid. The ink can also be considered as a liquid ejected from the head part 12 by the inkjet method. In this example, the head part 12 includes an inkjet head that ejects ink by the inkjet method, and ejects, from the inkjet head, an ultraviolet-curable ink (UV ink) that cures from a liquid state by irradiation of an ultraviolet ray. In this case, the ultraviolet-curable ink can be considered as an example of an ink that cures in accordance with a predetermined condition. The head part 12 further ejects a support material ink, which is an ink that becomes the material of a support layer 52, in addition to the ink that becomes the material of the shaped object 50. Due to this, the head part 12 forms the support layer 52 at a periphery of the shaped object 50 and the like as necessary. The support layer 52 can be considered as a layered structural object that supports at least a part of the shaped object 50 being shaped. The support layer 52 is formed as necessary at the time of shaping of the shaped object 50, and is removed after the shaping is completed. The head part 12 of this example includes, as an inkjet head, a head unit that ejects a plurality of types of inks different from one another. In this case, difference in type of ink can be considered as difference in color or use. In the following, for convenience of description, difference in type of ink including difference in use of the ink may be simply referred to as difference in color of the ink. A specific configuration of the head part 12 and the type of the ink used by the head part 12 will be described later in more detail.

The shaping table 14 is a table-shaped member that supports the shaped object 50 being shaped, and is disposed at a position facing the head part 12, and mounts, on the upper surface, the shaped object 50 being shaped and the support layer 52. The shaping table 14 of this example has a configuration movable in each of a sub scanning direction (X direction in the figure) and a layering direction (Z direction in the figure) set in advance in the shaping device 10 by being driven by the shaping table driving part 20. In this case, movement in the sub scanning direction or the layering direction can be considered as movement in a direction parallel to the sub scanning direction or the layering direction. The layering direction can be considered as a direction in which the shaping material is layered in the layered shaping method. In this example, the layering direction is a direction orthogonal to a main scanning direction (Y direction in the figure) and the sub scanning direction set in advance in the shaping device 10. Each of the plurality of ink tanks 16 is an ink container that stores ink. As the ink tank 16, for example, a known ink bottle can be suitably used. The plurality of ink tanks 16 of this example store the ink of each color ejected from the head part 12, and supplies the ink of each color from the outside of the head part 12 to the head part 12 in accordance with the progress of the operation of shaping.

The main scan driving part 18 is a driver that causes the head part 12 to perform a main scan operation (Y scan). The main scan operation can be considered as an operation of ejecting ink while moving in the main scanning direction. In this case, causing the head part 12 to perform the main scan operation can be considered as causing the inkjet head (head unit) of the head part 12 to perform the main scan. The main scan driving part 18 of this example causes the head part 12 to perform the main scan operation by fixing the position of the shaping table 14 and moving the head part 12 in the main scanning direction. A specific configuration of the main scan driving part 18 will be described later in more detail.

The shaping table driving part 20 is a driver that moves the shaping table 14, and moves the shaping table 14 in each of the sub scanning direction and the layering direction. The shaping table driving part 20 of this example moves the shaping table 14 in the sub scanning direction between intervals of the main scan operation during formation of one ink layer. Due to this, the shaping table driving part 20 causes the head part 12 to perform a sub scan (X scan) of moving in the sub scanning direction relative to the shaped object 50 being shaped. The sub scan can also be considered as an operation of moving relative to the shaping table 14 in the sub scanning direction by a feed amount set in advance. After one ink layer is formed and before formation of the next ink layer is started, the shaping table driving part 20 moves the shaping table 14 in a direction away from the head part 12 in the layering direction. Due to this, the shaping table driving part 20 causes the head part 12 to perform a layering direction scan (Z scan) moving in the in the layering direction relative to the shaped object 50 being shaped. The layering direction scan can also be considered as an operation of adjusting the relative position between the shaped object 50 being shaped and the head part 12 in the layering direction in line with the progress of the operation of shaping.

The control part 22 is a configuration including a CPU of the shaping device 10, and controls the operation of shaping of the shaped object 50 by controlling each part of the shaping device 10. In this case, the control part 22 generates slice data, which is data indicating a cross section of the shaped object 50 to be shaped, based on the shaped object data. In the operation of forming each ink layer constituting the shaped object 50, by controlling the operation of the head part 12 based on the slice data, the control part 22 causes the head part 12 to eject the ink of each color used for the shaping of the shaped object 50. According to this example, the shaping of the shaped object 50 can be appropriately executed.

Next, the configuration of the head part 12 of the shaping device 10 will be described in more detail. The head part 12 of this example includes an ink ejection part 102, a flattening roller unit 104, and a plurality of light source units 106. The ink ejection part 102 is a part of the head part 12 that ejects ink, and includes a carriage 202 and a plurality of head units 204a and 204b.

The carriage 202 is a holding member that holds the plurality of head units 204a and 204b, and holds each of the plurality of head units 204a and 204b so that the ejection direction of the ink becomes a direction toward the shaping table 14. As described below in detail, the flattening roller unit 104 and the light source unit 106 of the head part 12 of this example are disposed outside the carriage 202. Therefore, the carriage 202 can be considered to hold the plurality of head units 204a and 204b and not to hold each configuration (e.g., the flattening roller or the like) of the flattening roller unit 104 and each configuration of the light source unit 106. In this case, the flattening roller unit 104 and the light source unit 106 can be considered as being configured as a unit different from each configuration of the ink ejection part 102. In the carriage 202 of this example, a carriage base constituting a base part of the carriage 202 facing the shaping table 14 exchangeably (removably) holds the plurality of head units 204a and 204b. The carriage 202 holds the plurality of head units 204a and 204b arranged in the main scanning direction with their positions in the sub scanning direction aligned. In this case, the head units 204a and 204b can be considered to be arranged in an in-line arrangement such that the region for ejecting the ink in each main scan operation becomes the same.

The plurality of head units 204a and 204b are an example of an ejection head that ejects a shaping material. Each of the plurality of head units 204a and 204b of this example is an inkjet head that ejects inks of a plurality of colors different from one another, and includes a plurality of nozzle rows 212, each of which ejects ink supplied from any of the ink tanks 16 via supply paths of inks different from one another. In this case, the difference in the ink supply path can be considered as the supply paths for supplying the ink from the ink tank 16 to the head part 12 being independent from one another. The difference in the ink supply path to each of the nozzle rows 212 can be considered as each of the nozzle rows 212 receiving supply of the ink from the ink tanks 16 different from one another. The nozzle row 212 can be considered as a row of nozzles arranged with their positions shifted in a predetermined nozzle row direction. The plurality of nozzle rows 212 included in each of the head units 204a and 204b are arranged in the main scanning direction with the positions in the sub scanning direction aligned and with a direction parallel to the sub scanning direction as the nozzle row direction.

Each of the head units 204a and 204b is a four-color head unit having nozzle rows 212 for four colors. The head unit 204a is an example of a first head unit, and includes, as distinctively indicated as nozzle rows 212y, m, c, and k in the figure, the plurality of nozzle rows 212y to k that respectively eject color inks of colors different from one another. The color ink of each color ejected from the plurality of nozzle rows 212y to k of the head unit 204a is an ink for coloring used at the time of formation of a colored region of the shaped object 50. The color ink of each color is an example of a colored ink. Each of the plurality of nozzle rows 212y to k of the head unit 204a can be considered to ejection each of the color inks of a plurality of colors used for formation of the colored region. The nozzle row 212y is a nozzle row that ejects yellow color (Y color) ink. The nozzle row 212m is a nozzle row that ejects magenta color (M color) ink. The nozzle row 212c is a nozzle row that ejects cyan color (C color) ink. The nozzle row 212k is a nozzle row that ejects black color (K color) ink. Each color of YMCK is an example of a basic color (process color) of color expression in a subtractive color mixing method.

The head unit 204b is an example of a second head unit, and includes, as distinctively indicated as nozzle rows 212s, w, t, and x in the figure, the plurality of nozzle rows 212s to x that respectively eject ink of a color different from the color ink ejected from the head unit 204a. In this case, the nozzle row 212s is a nozzle row that ejects the support material ink. The nozzle row 212w is a nozzle row that ejects white ink. The white ink of this example is an example of a light reflective ink, and is used at the time of formation of a light reflecting region of the shaped object 50. The nozzle row 212t is a nozzle row that ejects clear ink. The clear ink can be considered to be a colorless, transparent ink. The clear ink can be considered as an uncolored translucent ink or an ink to which no coloring material is intentionally added. The clear ink of this example is used at the time of formation of the colored region of the shaped object 50 together with the ink of each color of YMCK.

The nozzle row 212x of the head unit 204b is a nozzle row for ejecting ink of various colors or uses as necessary. The nozzle row 212x is conceivable of being used as the second nozzle row for ink in which the consumption amount becomes particularly large at the time of shaping. In this case, the nozzle row 212x is conceivable of ejecting a support material ink, white ink, and the like. The nozzle row 212x is also conceivable of being used as a spare nozzle row. In this case, the nozzle row 212x is conceivable to be used instead when the nozzle row 212 of any of the head units 204a and 204b fails. The nozzle row 212x is also conceivable of being ejecting an ink of a special color other than the ink of each color described above.

The flattening roller unit 104 of the head part 12 is an example of the flattening member. As illustrated in (a) and (b) of FIG. 2, the flattening roller unit 104 of this example includes a flattening roller 402 and a plurality of motors 404 and 406, and is disposed at a position adjacent to the carriage 202 outside the carriage 202 in the ink ejection part 102 of the head part 12. The flattening roller 402 is a roller that flattens the ink layer, and flattens the ink layer by coming into contact with the surface of the ink layer and removing a part of the ink before curing at the time of the main scan operation. More specifically, the flattening roller 402 of this example flattens the ink layer by coming into contact with the uncured ink while rotating in a predetermined direction at the time of the main scan operation, and scraping off the ink at a position higher than a predetermined height. The motor 404 is an example of a rotation motor, and generates a driving force for rotating the flattening roller 402. The motor 406 is an example of a roller moving motor, and generates a driving force for moving the flattening roller 402 in the vertical direction. The motor 406 of this example moves the flattening roller 402 up and down in the vertical direction by supplying power to a mechanism part that moves the flattening roller 402 in the vertical direction.

The flattening roller unit 104 of this example is coupled to the carriage 202 of the ink ejection part 102 by a coupling section 112 on one side of the ink ejection part 102 in the main scanning direction. In this case, the flattening roller unit 104 being coupled to the carriage 202 can be considered as the carriage 202 and the flattening roller unit 104 being joined so that the flattening roller unit 104 moves in accordance with the carriage 202 when the head part 12 moves at the time of the main scan operation. This configuration can appropriately execute the flattening operation by the flattening roller 402 with the flattening roller 402 being disposed outside the carriage 202. This can appropriately perform shaping of the shaped object 50 with high accuracy.

The coupling section 112 of this example couples the flattening roller unit 104 and the carriage 202 by the attraction force of the magnet. This configuration can appropriately achieve a state where a change of the relative positions of the flattening roller unit 104 and the carriage 202 is easy, and the flattening roller unit 104 moves together with the carriage 202 at the time of the main scan operation. In this case, the manner of coupling between the flattening roller unit 104 and the carriage 202 can also be considered to be not in a state where the positional relationship of the both is fully fixed, but in a state where adjustment of the relative position is easily performed. Such manner of coupling can also be considered as a state in which the both are connected with a certain degree of looseness. The coupling achieved by the attraction force of the magnet as in this example can be considered as an example of joining that is easily separable and easily changed and adjusted in terms of positional relationship. In this case, the position (joining position) where the flattening roller unit 104 is attached to the carriage 202 can also be easily and appropriately adjusted.

Note that the coupling between the flattening roller unit 104 and the carriage 202 by the attraction force of the magnet may be achieved not necessarily by directly applying the attraction force of the magnet to the flattening roller unit 104 and the carriage 202 but by applying the attraction force of the magnet to the member fixed to each of the flattening roller unit 104 and the carriage 202. The coupling section 112 of this example is a part of the flattening roller unit 104, and the position is fixed with respect to the flattening roller 402. The coupling section 112 includes a magnet, and couples the flattening roller unit 104 and the carriage 202 by being attracted to any position of the ink ejection part 102 by the attraction force of the magnet. It is also conceivable of disposing the magnet not on the coupling section 112 of the flattening roller unit 104 but on the side of the ink ejection part 102. In this case, by having a metal member and the like attracted by the magnet, the coupling section 112 is coupled to the carriage 202 by the attraction force of the magnet presented on the ink ejection part 102 side. In a modification of the head part 12, the coupling section 112 may have a configuration different from that of the flattening roller unit 104. In this case, the coupling section 112 is attracted to, for example, any position of the flattening roller unit 104 by the attraction force of the magnet. The coupling section 112 may be a part of the ink ejection part 102. In a further modification of the head part 12, the coupling section 112 may couple the flattening roller unit 104 and the carriage 202 by a method other than the attraction force of the magnet. The manner of coupling between the flattening roller unit 104 and the carriage 202 will be described later in more detail.

The plurality of light source units 106 are unit components having a light source (UV light source) for curing the ink, and generate an ultraviolet ray for curing the ultraviolet-curable ink. The plurality of light source units 106 of this example are disposed on one end side and the other end side, respectively, in the main scanning direction of the head part 12 so as to sandwich the ink ejection part 102 and the flattening roller unit 104 therebetween. As the light source of the light source unit 106, for example, an ultraviolet LED (UVLED) or the like can be suitably used. It is also conceivable of using a metal halide lamp, a mercury lamp, or the like as the light source of the light source unit 106. In this example, the plurality of light source units 106 are also disposed outside the carriage 202 of the ink ejection part 102, and coupled to the carriage 202 so that the plurality of light source units 106 move along the carriage 202 at the time of the main scan operation. In this case, it is conceivable of performing coupling of the light source units 106 to the carriage 202 with a configuration different from the coupling of the flattening roller unit 104 to the carriage 202. More specifically, it is conceivable of coupling each of the plurality of light source units 106 so that the positional relationship thereof is fixed using a member or the like fixed with respect to a predetermined position of the ink ejection part 102 and each of the plurality of light source units 106. This configuration can appropriately join the light source unit 106 larger in weight than the flattening roller unit 104 to the ink ejection part 102. In this case, it can be considered that the coupling between the light source units 106 and the carriage 202 is stronger than the coupling between the flattening roller unit 104 and the carriage 202. In a modification of the head part 12, the coupling between the light source units 106 and the carriage 202 may also be performed by the attraction force of the magnet, similarly to the coupling between the flattening roller unit 104 and the carriage 202.

Use of the head part 12 having the above configuration enables the ink layer constituting the shaped object 50 to be appropriately formed. The shaped object 50 can be appropriately shaped by forming a plurality of ink layers in a layering manner. The head part 12 of this example can also achieve reduction in size and weight of the carriage 202 by the above configuration. In this case, the weight reduction of the carriage 202 can be considered as the weight reduction of the total weight of the configuration held by the carriage 202. More specifically, as described above, each of the head units 204a and 204b of this example ejects inks of a plurality of colors. In this case, as compared with the case of using a plurality of inkjet heads for single color that ejects only an ink of one color, the size and weight of the configuration for ejecting the inks of the plurality of colors of the same number of colors are reduced. Therefore, the head part 12 ejects inks of the plurality of colors using the head units 204a and 204b, whereby the reduction in size and weight of the carriage 202 can be appropriately achieved. In this example, by disposing the flattening roller unit 104 outside the carriage 202, it is possible to achieve further reduction in size and weight of the carriage 202.

Here, in this example, the plurality of head units 204a and 204b are removably attached to the carriage base of the carriage 202 by a predetermined attachment mechanism (attachment member). Each of the head units 204a and 204b of this example can be considered as an inkjet head having functions of a plurality of inkjet heads for single color that ejects inks of different colors or uses from one another. Head units such as the head units 204a and 204b can be considered as components that are integrated in units and collectively replaced at the time of repair or maintenance. The head units can also be considered as replacement unit components to be collectively replaced when any nozzle row in the head unit fails. The failure of the nozzle row can be considered as a failure or the like that requires replacement. The replacement unit component can be considered as a component to be replaced in the replacement work performed in the normal maintenance work of the shaping device 10. The normal maintenance work can be considered as maintenance work performed by a method described in a maintenance manual or the like. In this case, the head unit can also be considered as a configuration in which disassembly into the nozzle row for each color is not performed in the maintenance work.

The head units used as the head units 204a and 204b can be considered as a sales unit components sold as inkjet heads for a plurality of colors, for example. The plurality of nozzle rows of one head unit can be considered to be integrally formed in one component. In this case, the plurality of nozzle rows being integrally formed in one component of the head unit can be considered as the plurality of nozzle rows being formed at predetermined positions in a fixed-shape housing constituting the outer surface shape of the head unit. The plurality of nozzle rows of each head unit can be considered to be arranged with a predetermined positional relationship being kept. The position of each nozzle row of the head unit may be adjustable (fine adjustment) within a predetermined adjustable range. In this case, the plurality of nozzle rows being arranged with the predetermined positional relationship being maintained can be considered as the adjustable range corresponding to each nozzle row keeping the predetermined positional relationship. The plurality of nozzle rows being arranged with the predetermined positional relationship being maintained can also be considered as the positional relationship of the adjustment reference position in each nozzle row being determined. Each head unit has a nozzle plate that is a plate-shaped body formed by arranging through holes serving as nozzles of the nozzle row. In this case, it is possible to suitably use a nozzle plate in which nozzle rows for a plurality of colors are formed. Each of the head units 204a and 204b may have a plurality of nozzle plates. As each of the plurality of nozzle plates, for example, a nozzle plate having a plurality of nozzle rows may be used. In this case, a configuration in which, for example, each of the head units 204a and 204b has two nozzle plates, and the nozzle rows for two colors are formed in each nozzle plate (one nozzle plate) can be considered.

When considering the head unit in a more generalized manner, it is also conceivable of using, as the head unit, a configuration in which, for example, a plurality of inkjet heads for single color are combined. Also in this case, by using, as a unit of replacement, a configuration in which a plurality of inkjet heads for single color are compactly brought together, it is possible to reduce the size and weight of the carriage as compared with a case where each inkjet head for single color is individually attached to the carriage. In this case, fine adjustment of the positional relationship in the head unit may be enabled for each inkjet head for single color brought together in the head unit.

As described above, the carriage 202 included in the ink ejection part 102 of this example is a configuration for holding the plurality of head units 204a and 204b. On the other hand, for the flattening roller unit 104, it is conceivable of separately using a holding member for holding the flattening roller 402. In this case, the holding member of the flattening roller unit 104 can also be considered as a carriage or the like of the flattening roller unit 104. In this case, the configuration of the flattening roller unit 104 can be considered as holding the flattening roller 402 by a carriage separate from the carriage 202 of the ink ejection part 102. The carriage 202 of the ink ejection part 102 can be considered as holding the head units 204a and 204b without holding the flattening roller 402. In this case, the coupling section 112 can also be considered as a configuration of coupling the carriage for the flattening roller 402 included in the flattening roller unit 104 to the carriage 202 of the ink ejection part 102.

In the head part 12 of this example, the head units 204a and 204b are not simply used, but the type of ink ejected by each of the head units 204a and 204b is determined in line with the use of ink. More specifically, as described above, in this example, the ink of each color of YMCK used for formation of the colored region of the shaped object 50 is ejected by the nozzle row of the plurality of colors of the head unit 204a. Then, other inks are ejected by the plurality of nozzle rows of the head unit 204b. Thus, the ink of each color of YMCK whose consumption amount is reduced at the time of shaping of the shaped object 50 is ejected only from the head unit 204a. This configuration can appropriately reduce the difference in consumption amount between the inks ejected from the same head unit. This can appropriately prevent the cost of component replacement of the shaping device 10 from being excessively increased by replacement of the head unit. This point will be described below in more detail in association with the configuration of the shaped object 50 shaped by the shaping device 10.

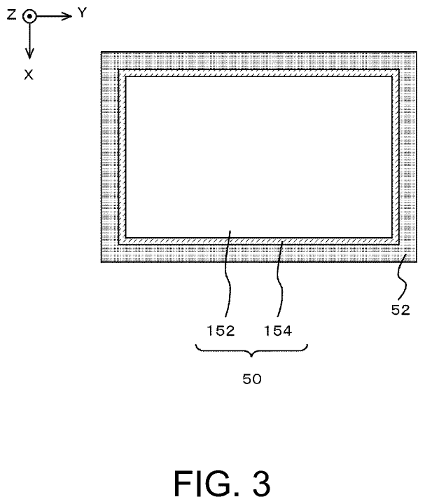

FIG. 3 is a view illustrating an example of the configuration of the shaped object 50 shaped by the shaping device 10 (see FIG. 1), and illustrates an example of the configuration of an X-Y cross section, which is a cross section of the shaped object 50 orthogonal to the layering direction (Z direction). In this case, the configurations of a Z-X cross section and a Z-Y cross section of the shaped object 50, which are perpendicular to the Y direction and the Z direction, have similar configurations. As described above, the shaping device 10 of this example shapes the shaped object 50 whose surface is colored using the color ink (ink of each color of YMCK) ejected from of the head unit 204a (see FIG. 1) included in the ink ejection part 102 of the head part 12. In this case, the surface of the shaped object 50 being colored can be considered as at least a part of a region where the hue can be visually recognized from the outside of the shaped object 50 being colored. The shaping device 10 of this example shapes the shaped object 50 including a light reflecting region 152 and a colored region 154. The support layer 52 is formed at the periphery of the shaped object 50 and the like as necessary.

The light reflecting region 152 is a light reflective region for reflecting light entering from the outside of the shaped object 50 through the colored region 154 and the like. The colored region 154 can also be considered as a region that reflects light entering from the outside of the shaped object 50 when coloring in full-color expression is performed on the surface of the shaped object 50. The full-color expression can be considered as an expression of a color performed with a possible combination of the subtractive color mixing method with an ink of a process color. The shaping device 10 of this example forms the light reflecting region 152 serving also as an inner region of the shaped object 50 using the white ink ejected from the head unit 204b (see FIG. 1) of the ink ejection part 102. In this case, the inner region can be considered as a region constituting the interior of the shaped object 50. In this case, the white ink used for formation of the light reflecting region 152 can be considered as an example of the shaping ink used for formation of the inner region. In a modification of the shaped object 50, the inner region may be formed as a region different from the light reflecting region 152. In this case, the shaping device 10 forms the inner region using any ink other than the support material ink. The light reflecting region 152 is formed at the periphery of the inner region.

The colored region 154 is a region colored by the ink of each color of YMCK ejected from the head unit 204a. The shaping device 10 of this example forms the colored region 154 at the periphery (outside) of the light reflecting region 152 using the ink of each color of YMCK ejected from the head unit 204a and the clear ink ejected from the head unit 204b. In this case, the shaping device 10 expresses various colors by adjusting the ejecting amount of the color ink of each color to each position. The clear ink is used for compensating for a change in the total amount of the color ink caused by the difference in color. This configuration can appropriately color each position of the colored region 154 with a desired color. Thus, the shaped object 50 having been colored can be appropriately shaped.

Here, the colored region 154 of this example is formed only with the color inks of a plurality of colors (ink of each color of YMCK) ejected from the head unit 204a and the clear ink ejected from the head unit 204b. When the colored region 154 is formed on the surface of the shaped object 50 as in this example, the consumption amount of the color inks of the plurality of colors used for formation of the colored region 154 becomes significantly smaller than the consumption amount of the white ink used for formation of the light reflecting region 152 constituting the interior of the shaped object 50 and the support material ink used for formation of the support layer 52. As a result, focusing on the number of shots of ejecting the ink from each nozzle row of the head units 204a and 204b at the time of shaping, the number of shots of the white ink and the support material ink becomes significantly larger than the number of shots of the color ink.

In general, when the number of shots from any of the nozzle rows increases, the head units 204a and 204b become likely to fail. As described above, the head units 204a and 204b are usually replaced in units of head unit. Therefore, the replacement time of the head units 204a and 204b is usually determined in accordance with the number of shots in the nozzle row having the largest number of shots. In this case, if one head unit (any of the head units 204a and 204b) has nozzle rows having greatly different consumption amounts in a mixed manner, the replacement time arrives early due to the influence of some nozzle rows, and thus the replacement frequency of the head unit increases, leading to an increase in the operation cost of the shaping device 10. More specifically, for example, when both of the head units 204a and 204b are provided with a nozzle row for color ink of any color, and one head unit has the nozzle row for the color ink and the nozzle row for the white ink or the support material ink, it is conceivable that the replacement frequency becomes high for both the head units 204a and 204b. As a result, it is conceivable that the replacement frequency of the head unit of the shaping device 10 increases.

On the other hand, in this example, the nozzle rows for color ink having a small consumption amount are brought together in the head unit 204a, and the nozzle rows for other inks are brought together in the head unit 204b. The head unit 204a ejects only the color ink. This configuration can dispose, in different head units from one another, the nozzle row of the white ink and the support material ink, which are inks whose consumption amounts become particularly large, and the nozzle rows for the color inks. Therefore, this example can appropriately reduce the difference in consumption amount for the inks of the plurality of colors ejected from each of the head units 204a and 204b. This enables replacement of the head units 204a and 204b more efficiently and appropriately.

Note that as described above, in this example, of the inks used for formation of the colored region 154, the clear ink is ejected from the head unit 204b. However, also in this case, by bringing together, in the head unit 204a, the nozzle rows for the color inks whose consumption amount becomes particularly small, it is possible to appropriately reduce the difference in consumption amount of the ink in the head unit 204a. The clear ink tends to have a consumption amount more than that of the color ink. Therefore, the head unit 204b that ejects the white ink or the support material ink can also be considered to become smaller in difference of the consumption amount of ink than that in a case of providing a nozzle row for any color ink, for example.

In this example, it is conceivable that the head unit 204b that ejects the ink having a large consumption amount reaches the end of life earlier than the head unit 204a. Therefore, as a maintenance method of the shaping device 10, it is preferable to make the replacement cycle of the head unit 204b shorter than that of the head unit 204a. In this case, it is conceivable of urging a user to replace the head units 204a and 204b based on an operating amount in which the shaping device 10 operates before a failure actually occurs in the head units 204a and 204b, for example. In this case, it is conceivable of associating in advance the operating amount of the shaping device 10 and the replacement timing of the head units 204a and 204b. The association between the operating amount and the replacement timing is made different between head unit 204a and head unit 204b, thereby urging the user to replace each of the head units 204a and 204b so that head unit 204b is replaced more frequently than the head unit 204a. This configuration can appropriately replace the head unit 204b that ejects ink having a large consumption amount in a cycle shorter than that of the head unit 204a. This can more appropriately perform the maintenance of the shaping device 10 in accordance with the use and the like of the ink ejected from each of the head units 204a and 204b.

In this case, the shaping device 10 further includes, for example, a storage part that stores association information in which the operating amount and the replacement timing are associated and a display part for urging the user to replace the head units 204a and 204b. The control part 22 (see FIG. 1) of the shaping device 10 causes the display part to display a message urging the user to replace the head units 204a and 204b based on this association information and the operating amount of the shaping device 10. As the operating amount of the shaping device 10, for example, it is conceivable of managing the operating time and the like in which the shaping device 10 executes the operation of shaping. As the operating amount of the shaping device 10, it is also conceivable of managing the elapsed time (e.g., the number of elapsed days) from the replacement of each of the head units 204a and 204b. As the operating amount of the shaping device 10, it is also conceivable of managing the amount of the ink ejected from each nozzle row of the head units 204a and 204b.

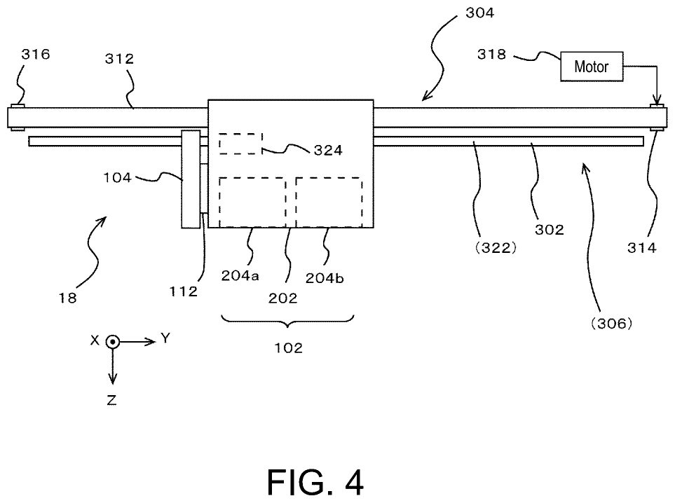

Next, features of the main scan driving part 18 (see FIG. 1) and the flattening roller unit 104 (see FIG. 1) of the head part 12 in this example will be described in more detail. FIG. 4 is a view describing the main scan driving part 18 and the head part 12 in more detail, and illustrates an example of a specific configuration of the main scan driving part 18 together with a part of the head part 12. For convenience of illustration, of the head part 12, FIG. 4 omits the light source unit 106 (see FIG. 1), and illustrates the ink ejection part 102 and the flattening roller unit 104.

As described above, the head part 12 of this example includes the flattening roller unit 104 and the light source units 106 outside the carriage 202 of the ink ejection part 102. In this case, the main scan driving part 18 causes the head part 12 to perform the main scan operation while holding the flattening roller unit 104 and the light source unit 106 outside the carriage 202 of the head part 12. The main scan driving part 18 of this example includes a guide rail 302, a drive mechanism 304, and a linear encoder 306. The guide rail 302 is an example of a guide member that guides movement of the carriage 202 of the ink ejection part 102 in the main scanning direction. The guide rail 302 of this example is a rail-shaped member extending in the main scanning direction, and holds the carriage 202 so that the carriage 202 becomes movable along the rail. In this case, the guide rail 302 enables the carriage 202 to move along the guide rail 302 by engaging, with the guide rail 302, the carriage 202 itself or a member whose position is fixed with respect to the carriage 202.

It is conceivable of using, for example, a configuration including a rail portion and a moving portion as the guide rail 302. In this case, the rail portion is a rail-shaped part of the guide rail 302. The moving portion is configured to move along the rail portion. When the guide rail 302 having this configuration is used, the guide rail 302 movably holds the carriage by fixing the carriage 202 to the moving portion. The carriage 202 is moved in the main scanning direction by moving the moving portion along the rail portion. As such the guide rail 302, for example, a known LM guide (registered trademark) or the like can be suitably used. The LM guide can be considered as a member that guides a linear motion portion of a machine by a rolling motion.

The guide rail 302 of this example holds the flattening roller unit 104 movably in the main scanning direction independently of the ink ejection part 102. When the guide rail 302 having the rail portion and the moving portion is used, holding the flattening roller unit 104 independently of the ink ejection part 102 by the guide rail 302 can be considered as fixing the flattening roller unit 104 with respect to the moving portion of the guide rail 302 separately from the ink ejection part 102. In this case, it is conceivable of fixing the flattening roller unit 104 with respect to the moving portion at a position different from the fixing position of the ink ejection part 102. As described above, the holding member for holding the flattening roller 402 of the flattening roller unit 104 can be considered as a carriage or the like of the flattening roller unit 104 separate from the carriage 202 of the ink ejection part 102. In this case, holding the flattening roller unit 104 independently of the ink ejection part 102 by the guide rail 302 can also be considered as holding the carriage of the flattening roller unit 104 and the carriage 202 of the ink ejection part 102 by the guide rail 302.

Although not illustrated, the guide rail 302 holds the light source units 106 movably in the main scanning direction independently of the ink ejection part 102 and the flattening roller unit 104. In this case, the guide rail 302 movably holding each of the flattening roller unit 104 and the light source unit 106 can be considered as making each of the flattening roller unit 104 and the light source units 106 movable along the guide rail 302 by engaging, with the guide rail 302, a part of each of the flattening roller unit 104 and the light source unit 106. It can be considered that the guide rail 302 holds the flattening roller unit 104 and the light source unit 106 movably in the main scanning direction outside the carriage 202 of the ink ejection part 102.

This configuration can support the weight of each configuration of the head part 12 in a dispersing manner at a plurality of positions of the guide rail 302. Therefore, this configuration can appropriately prevent the weight from concentrating on the position where the guide rail 302 holds the carriage 202, as compared with the case where the carriage 202 of the ink ejection part 102 also holds the flattening roller and the like. This can appropriately prevent bend from occurring in the guide rail 302. As can be understood from the configuration and the like illustrated in (b) of FIG. 2, the guide rail 302 of this example supports the carriage 202 in a cantilever state by supporting the carriage 202 from one side in the sub scanning direction. In this case, when the weight of the carriage 202 increases, the side of the carriage 202 opposite to the guide rail 302 bends downward, thereby easily bringing into a so-called bowing state. On the other hand, this example can also appropriately prevent such problem by disposing the flattening roller unit 104 outside the carriage 202.

Here, as described above, it is conceivable of using the configuration including the rail portion and the moving portion as the guide rail 302. In this case, it is conceivable that the guide rail 302 holds the flattening roller unit 104 and the light source unit 106 by attaching the flattening roller unit 104 and the light source unit 106 to the moving portion. In this case, it is conceivable of attaching the ink ejection part 102, the flattening roller unit 104, and the plurality of light source units 106 to one moving portion. This configuration can appropriately move the flattening roller unit 104 and the light source unit 106 together with the carriage 202 of the ink ejection part 102. In this case, by coupling the carriage 202 and the flattening roller unit 104 by the coupling section 112, it is possible to move the flattening roller unit 104 more appropriately. The guide rail 302 may have a plurality of moving portions that move along one rail member. In this case, each of the flattening roller unit 104 and the light source unit 106 may be fixed to a moving portion different from the moving portion to which the ink ejection part 102 is fixed. This configuration can more appropriately prevent the weight from concentrating on the position where the guide rail 302 holds the carriage 202.

As described above, the flattening roller unit 104 of this example is disposed only on one side in the main scanning direction with respect to the ink ejection part 102. In this regard, for example, when considering holding also the flattening roller by the carriage 202 of the ink ejection part 102, if the flattening roller is disposed only on one side in the main scanning direction of the carriage 202, it is conceivable that a difference occurs in weight between one side and the other side in the main scanning direction. In this case, when the size and weight of the carriage 202 are reduced by using the head units 204a and 204b, it is conceivable that the inclination of the carriage 202 where the side provided with the flattening roller of the carriage 202 is lowered easily occur due to the weight of the flattening roller. On the other hand, by disposing the flattening roller unit 104 outside the carriage 202, this example can more appropriately prevent the inclination of the carriage 202 from occurring due to the weight of the flattening roller even when the flattening roller is disposed only on one side of the carriage 202.

At the time of the main scan operation, it is conceivable of reciprocating the head part 12 in the main scanning direction, for example, and ejecting ink from the ink ejection part 102 in both a forward route and a return route. When the flattening roller unit 104 is disposed only on one side of the ink ejection part 102 in the main scanning direction as in this example, it is conceivable of bringing the flattening roller 402 into contact with the ink layer only at the time of movement of the head part 12 in an orientation in which the flattening roller unit 104 becomes on a rear side relative to the ink ejection part 102. Therefore, by moving the flattening roller 402 in the vertical direction by the driving force of the motor 406, the flattening roller unit 104 of this example lowers the position of the flattening roller 402 to bring the ink layer and the flattening roller 402 into contact with each other at the time of the main scan operation in which the head part 12 moves in the orientation in which the flattening roller unit 104 becomes on the rear side relative to the ink ejection part 102. At the time of the main scan operation in which the head part 12 moves in an orientation in which the flattening roller unit 104 becomes on a front side relative to the ink ejection part 102, the flattening roller 402 is retracted upward, and the ink layer and the flattening roller 402 are not brought into contact with each other. This example can easily and appropriately change the position of the flattening roller 402 in the vertical direction. This can more appropriately perform flattening of the ink layer when forming the ink layer by the main scan operation of reciprocation.

Note that when the flattening roller unit 104 includes the plurality of motors 404 and 406 as in this example, it is conceivable that the weight of the flattening roller unit 104 becomes heavy. In this case, when the configuration corresponding to the flattening roller unit 104 is held by the carriage 202 of the ink ejection part 102, it is conceivable that the problem of weight increase of the carriage 202 becomes particularly remarkable. Therefore, in this example, it can also be considered that the effect obtained by disposing the flattening roller unit 104 outside the carriage 202 becomes particularly large.

The drive mechanism 304 is a drive mechanism that moves the carriage 202 of the ink ejection part 102 along the guide rail 302. The drive mechanism 304 of this example includes a belt 312, a driving pulley 314, a driven pulley 316, and a motor 318. The belt 312 is a belt member having an annular shape stretched along the moving range of the carriage 202 in the main scanning direction, and rotationally moves along a rotation path having the driving pulley 314 and the driven pulley 316 as ends on one side and the other side in the main scanning direction. The belt 312 moves the carriage 202 in the main scanning direction by rotationally moving, in a state of being attached to a predetermined position, the carriage 202 or a part of the ink ejection part 102 with a position fixed with respect to the carriage 202. In this case, by appropriately reversing the orientation of rotation, the belt 312 reciprocates the carriage 202 within the moving range of the carriage 202 in the main scanning direction. In this case, the drive mechanism 304 can be considered as a mechanism that moves the carriage 202 in the main scanning direction by rotationally moving the belt 312.

The driving pulley 314 and the driven pulley 316 are pulleys for stretching and rotationally moving the belt 312. The driving pulley 314 is a pulley that rotates in accordance with power received from the motor 318, and applies the belt 312 with power for rotational movement of the belt 312 by meshing with the belt 312 on one side in the main scanning direction. The driven pulley 316 is a pulley that meshes with the belt 312 on the other side in the main scanning direction, and rotates in accordance with the rotational movement of the belt 312. The motor 318 is a motor that rotates the driving pulley 314, and rotates the driving pulley 314 in accordance with an instruction from the control part 22 (see FIG. 1) of the shaping device 10. This configuration can appropriately move the carriage 202 at the time of the main scan operation. This can appropriately move, in the main scanning direction, the head units 204a and 204b and the like held by the carriage 202.

Here, the belt 312 of this example is not directly connected to the flattening roller unit 104. Although not illustrated, the belt 312 is also not directly connected to the light source units 106. Therefore, at the time of the main scan operation, by moving the ink ejection part 102, the drive mechanism 304 moves the flattening roller unit 104 and the light source units 106 in accordance with the movement of the ink ejection part 102. More specifically, as described above, the flattening roller unit 104 and the light source units 106 of this example are coupled to the carriage 202 of the ink ejection part 102 by the coupling section 112 and the like. In this case, when the belt 312 moves the carriage 202 in the main scanning direction, the flattening roller unit 104 and the light source units 106 also move in the main scanning direction in accordance with the movement of the carriage 202. Therefore, this example can appropriately move each configuration of the head part 12 in the main scanning direction at the time of the main scan operation. As can be understood from the above description and the like, in this case, the belt 312 not being directly connected to the flattening roller unit 104 can be considered as the belt 312 not directly moving the flattening roller unit 104 when the belt 312 is rotationally moved, but the ink ejection part 102 moving by the rotational movement of the belt 312 and the flattening roller unit 104 moving with the movement of the ink ejection part 102 by the ink ejection part 102 and the flattening roller unit 104 being coupled by the coupling section 112. In this example, the belt 312 not being directly connected to the flattening roller unit 104 can be considered as the power accompanying the rotational movement of the belt 312 being transmitted to the flattening roller unit 104 via the carriage 202 of the ink ejection part 102 and the coupling section 112 and being not transmitted from other paths. The belt 312 not being directly connected to the flattening roller unit 104 can also be considered as the flattening roller unit 104 not being fixed to the belt 312 in a state where the carriage 202 and the flattening roller unit 104 are not coupled by the coupling section 112.

As described above, the motor 318 of this example rotates the driving pulley 314 in accordance with the instruction from the control part 22. In this case, the control part 22 controls rotation of the driving pulley 314 by controlling the operation of the motor 318 in accordance with output of the linear encoder 306. The linear encoder 306 of this example includes a linear scale 322 and a sensor 324. The linear scale 322 is a member indicating a scale as a reference of a position, and is disposed to extend in the main scanning direction along the guide rail 302. The linear scale 322 of this example indicates each position of the guide rail 302 by being attached to the guide rail 302. The sensor 324 is an optical sensor that reads the scale of the linear scale 322, and is disposed at a predetermined position where the position of the ink ejection part 102 with respect to the carriage 202 is fixed. This configuration can appropriately detect the position of the carriage 202 with high accuracy by reading the scale of the linear scale 322 by the sensor 324. By controlling the operation of the motor 318 based on the detection result of the sensor 324, the control part 22 can move the carriage 202 while detecting the position of the carriage 202. Therefore, this example can appropriately control movement of the carriage 202 with high accuracy at the time of the main scan operation.

Note that as described above, this example can be considered as a configuration in which the linear scale 322 and the sensor 324 of the linear encoder 306 are included in the main scan driving part 18. However, depending on how to divide the configuration of the shaping device 10, the sensor 324 of the linear scale 322 can also be considered as a configuration of the head part 12 or the ink ejection part 102. It is conceivable of not using the linear encoder 306 as a member different from the guide rail 302 but using the guide rail 302 having the function of a linear encoder, for example.

As described above, this example can appropriately move each configuration of the head part 12 in the main scanning direction at the time of the main scan operation. Use of the head units 204a and 204b for the ink ejection part 102 of the head part 12 can appropriately achieve reduction in size and weight of the carriage 202. In this case, a Y bar structure, which is a part in the main scan driving part 18 extending in the main scanning direction, can be appropriately simplified in accordance with the carriage 202 that has been reduced in size and weight. Furthermore, in this case, by holding the flattening roller unit 104 and the light source units 106 independently of the ink ejection part 102 by the guide rail 302, even when the Y bar structure is simplified, it is possible to appropriately prevent bend and the like of the guide rail 302, and appropriately support each configuration of the head part 12.

At the time of the main scan operation, it becomes necessary to control, with high accuracy, the timing of ejecting the ink from the ink ejection part 102. Therefore, at the time of the main scan operation, of the positions of each configuration of the head part 12, the position of the ink ejection part 102 becomes particularly important. On the other hand, regarding the flattening roller unit 104 and the light source units 106, the accuracy required at the position in the main scanning direction is lower than that of the ink ejection part 102. Therefore, in this example, as described above, the carriage 202 is moved by the belt 312 while the position of the carriage 202 of the ink ejection part 102 is detected by the linear encoder 306. The flattening roller unit 104 and the light source units 106 are moved in accordance with the movement of the carriage 202. Therefore, this example can appropriately control the position of the ink ejection part 102 in the main scanning direction with high accuracy.

In this example, by disposing the flattening roller unit 104 outside the carriage 202 of the ink ejection part 102, and coupling the carriage 202 and the flattening roller unit 104 in a predetermined configuration, it becomes possible to more easily and appropriately perform adjustment of the inclination of the carriage 202 and adjustment of the height of the flattening roller 402 of the flattening roller unit 104. The manner of coupling between the flattening roller unit 104 and the carriage 202 and the like will be described below in more detail.

When the flattening roller is also held by the carriage 202 of the ink ejection part 102, for example, when adjustment of changing the inclination of the carriage 202 is performed, a direct change occurs also in the height of the flattening roller in the vertical direction. In this case, the inclination of the carriage 202 can be considered as an inclination with respect to the horizontal direction of a surface facing the shaping table 14 (see FIG. 1) of the carriage 202. The inclination with respect to the horizontal direction can also be considered as an inclination with respect to a horizontal plane. The height of the flattening roller can be considered as a height (position in the vertical direction) at which flattening is performed by the flattening roller. On the other hand, when disposing the flattening roller unit 104 outside the carriage 202 as in this example, it is possible to make it less likely to generate a direct influence on the height of the flattening roller 402 of the flattening roller unit 104 due to the adjustment of the inclination of the carriage 202. Also, when performing adjustment of the height of the flattening roller 402, it is possible to make it less likely to generate a direct influence on the inclination of the carriage 202 by the adjustment of the height of the flattening roller 402.

In this regard, as described above, by being coupled to the carriage 202 of the ink ejection part 102 by the attraction force of the magnet, the flattening roller unit 104 of this example is coupled to the carriage 202. In this case, as compared with a case where the positional relationship between the flattening roller unit 104 and the carriage 202 is firmly fixed, for example, by screwing or the like, an influence of one of the inclination of the carriage 202 and the height of the flattening roller 402 by a change in the other becomes less likely to occur. Such manner of coupling between the carriage 202 and the flattening roller unit 104 can also be considered as coupling between the both in a state where the flattening roller unit 104 moves together with the carriage 202 when the carriage 202 is moved along the guide rail 302 and fine adjustment of the inclination, height, or the like of one of the carriage 202 and the flattening roller unit 104 can be performed without moving the other.

As described above, the flattening roller unit 104 of this example is supported by the guide rail 302 by itself independently of the carriage 202 of the ink ejection part 102. The flattening roller unit 104 is coupled to the carriage 202 by the attraction force of the magnet. The coupling by the attraction force of the magnet can be considered as loose joining as compared with fixing by screwing or the like. Therefore, as long as performing adjustment of the inclination of the carriage 202, it is possible to appropriately perform the adjustment with respect to the carriage 202 while appropriately suppressing the influence on the height of the flattening roller 402 of the flattening roller unit 104. On the contrary, it is also possible to perform adjustment or the like of the height of the flattening roller 402 by changing the position of the flattening roller unit 104 while suppressing the influence on the inclination and the like of the carriage 202. Therefore, this example can more appropriately perform adjustment of the inclination of the carriage 202, adjustment of the height of the flattening roller 402, and the like, independently of each other. This makes it possible to easily and appropriately perform these adjustments with high accuracy.

The flattening roller unit 104 of this example is coupled to the carriage 202 so that the position of the flattening roller 402 in the vertical direction is adjustable without changing the inclination of the carriage 202 with respect to the horizontal direction by being coupled to the carriage 202 by the attraction force of the magnet. In this case, the position of the flattening roller 402 in the vertical direction being adjustable without changing the inclination of the carriage 202 with respect to the horizontal direction can be considered as not changing the inclination of the carriage 202 when the adjustment amount of the position of the flattening roller 402 falls within a predetermined range. Not changing the inclination of the carriage 202 can be considered as not substantially changing the inclination of the carriage 202 in accordance with the accuracy of shaping required at the time of shaping. Not substantially changing the inclination of the carriage 202 can be considered as being able to perform shaping without performing readjustment of the inclination of the carriage 202. This configuration can appropriately perform adjustment of the height of the flattening roller 402 without affecting the inclination of the carriage 202. This can more appropriately adjust the height of the flattening roller 402 with a high degree of freedom.

In this case, it is conceivable of executing adjustment of the position of the flattening roller 402 by adjustment of the entire position of the flattening roller unit 104. The adjustment of the entire position of the flattening roller unit 104 can be considered as adjustment of changing the relative position of the flattening roller unit 104 with respect to the carriage 202. It is also conceivable that adjustment (e.g., fine adjustment) of the position of the flattening roller 402 is performed by changing the position of the flattening roller 402 in the vertical direction by the driving force of the motor 406, for example. In this case, it is conceivable of further adjusting the position of the flattening roller 402 in the vertical direction by the driving force of the motor 406 after adjusting the entire position of the flattening roller unit 104. This configuration can more appropriately adjust the height of the flattening roller 402 with high accuracy.

The flattening roller unit 104 can also be considered to be coupled to the carriage 202 so that the inclination of the carriage 202 with respect to the horizontal direction is adjustable without changing the position of the flattening roller 402 in the vertical direction by being coupled to the carriage 202 by the attraction force of the magnet. In this case, the inclination of the carriage 202 with respect to the horizontal direction is adjustable without changing the position of the flattening roller 402 can be considered as not changing the position of the flattening roller 402 when the adjustment amount of the inclination of the carriage 202 falls within the predetermined range. Not changing the position of the flattening roller 402 can be considered as not substantially changing the position of the flattening roller 402 in accordance with the accuracy of shaping required at the time of shaping. Not substantially changing the position of the flattening roller 402 can be considered as being able to perform shaping without performing readjustment of the position of the flattening roller 402. This configuration can appropriately perform adjustment of inclination of the carriage 202 without affecting the height of the flattening roller 402. This can more appropriately adjust the inclination of the carriage 202 with a high degree of freedom.

Next, supplementary explanation regarding each of the above configurations will be given. In the above example, regarding the arrangement of the plurality of head units 204a and 204b held by the carriage 202 of the ink ejection part 102, the case of arranging in the main scanning direction with their positions in the sub scanning direction aligned has been mainly described. In a modification of the head part 12, the arrangement of the plurality of head units 204a and 204b may be different from the above. In this case, it is conceivable of holding the plurality of head units 204a and 204b arranged with the positions in the sub scanning direction being shifted by the carriage 202, for example. In the above example, the case where the number of head units held by the carriage 202 of the ink ejection part 102 is 2 has been mainly described. In a modification of the head part 12, the number of head units held by the carriage 202 may be 3 or more. Also in this case, by ejecting the ink of each color of YMCK, for example, from any head unit and ejecting the inks of other colors from another head unit, it is possible to appropriately reduce the difference in consumption amount for the inks of a plurality of colors ejected from one head unit.

As described above, in the head part 12 of this example, the flattening roller unit 104 is disposed outside the carriage 202 of the ink ejection part 102. In this case, various effects other than the above can be obtained. More specifically, as described above, at the time of the main scan operation, the flattening roller 402 of the flattening roller unit 104 rotates in accordance with the driving force of the motor 404 in the state of being in contact with the ink layer. In this case, minute vibration becomes likely to occur as the flattening roller 402 rotates while receiving the force due to the contact. Therefore, when the flattening roller 402 is held by the carriage 202 together with the head units 204a and 204b, the influence of the vibration generated at the position of the flattening roller 402 easily reaches the head units 204a and 204b. As a result, it is conceivable that the accuracy of ink ejection in the head units 204a and 204b is affected. On the other hand, in this example, as described above, the flattening roller unit 104 is disposed outside the carriage 202, and the carriage 202 and the flattening roller unit 104 are coupled by the attraction force of the magnet. This configuration can appropriately prevent the influence of the vibration generated at the position of the flattening roller 402 from reaching the head units 204a and 204b. This enables the head units 204a and 204b to more appropriately perform ejection of the ink with high accuracy.

As described above, in the drive mechanism 304 of the main scan driving part 18 of this example, the belt 312 is not directly connected to the flattening roller unit 104 and the light source units 106. In this case, since the flattening roller unit 104 is not directly connected to the belt 312, adjustment of the position and the like can be considered to be easily performed. Therefore, it can be considered that it is particularly preferable that the flattening roller unit 104 be not directly connected to the belt 312. On the other hand, in the case of the light source units 106, since the weight is larger than that of the flattening roller unit 104, it is also conceivable of fixing them to the belt 312. This configuration enables the main scan driving part 18 to more reliably hold the light source units 106.

In the above example, the configuration in which the flattening roller unit 104 is disposed on one side of the ink ejection part 102 in the main scanning direction has been mainly described. In a modification of the head part 12, the flattening roller unit 104 may be disposed on both sides of the ink ejection part 102 in the main scanning direction. This configuration can flatten the ink layer in both the forward route and the return route when forming the ink layer by the main scan operation of reciprocation. When disposing the flattening roller unit 104 outside the carriage 202 of the ink ejection part 102 as in this example, it is possible to more easily perform attachment and removal of the flattening roller unit 104. Therefore, the position of disposing the flattening roller unit 104 may be switched to only one side or both sides of the ink ejection part 102 in accordance with the quality and the like required for shaping.

In the above example, regarding the coupling between the carriage 202 of the ink ejection part 102 and the flattening roller unit 104, the configuration of joining the carriage 202 and the flattening roller unit 104 by the attraction force of the magnet has been mainly described. In a modification of the head part 12, coupling between the carriage 202 and the flattening roller unit 104 may be performed by a method other than the attraction force of the magnet. Also in this case, similarly to the above configuration, it is preferable to use a configuration in which the flattening roller unit 104 moves together with the carriage 202 at the time of the main scan operation and the inclination of the carriage 202 and the height of the flattening roller 402 can be appropriately adjusted.

In the above example, the configuration using the head units 204a and 204b as the inkjet heads of the ink ejection part 102 has been mainly described. However, in a modification of the head part 12, an inkjet head for single color may be used for the ink ejection part 102. In this case, the carriage 202 of the ink ejection part 102 holds a plurality of inkjet heads in line with the type of ink to use. Also, this configuration can obtain a similar effect to that described above regarding disposing the flattening roller unit 104 outside the carriage 202.

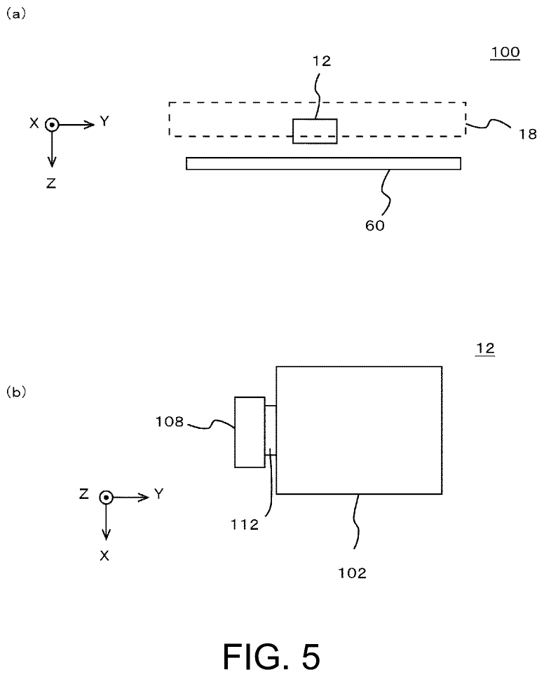

As described above, the shaping device 10 of this example is an example of a liquid ejection device that ejects liquid. In this case, the configuration included in the shaping device 10 can also be considered as an example of the configuration of the liquid ejection device. As described above, in the shaping device 10 of this example, the head part 12 includes the ink ejection part 102 and the flattening roller unit 104. In this case, the flattening roller unit 104 can be considered as an example of a function member. The function member can be considered as a member having a predetermined function different from that of the ejection head. In this case, the configuration of the liquid ejection device can also be considered as the function member being disposed outside the carriage of the ink ejection part 102 and the function member and the carriage being coupled so as to move with the carriage at the time of the main scan operation. Considering with focus on such features, regarding the configuration of the liquid ejection device, it is also conceivable of coupling a function member having a function different from that of the flattening roller unit 104 to the carriage of the ink ejection part 102. As the liquid ejection device, it is also conceivable of using a device for a use different from the shaping device 10. More specifically, as the liquid ejection device, it is also conceivable of using a printing apparatus that performs printing on a medium. In this case, it is conceivable of using a liquid ejection device having the configuration illustrated in FIG. 5.

FIG. 5 is a view describing the liquid ejection device 100 different from the shaping device. (a) of FIG. 5 illustrates an example of the configuration of the liquid ejection device 100. (b) of FIG. 5 illustrates an example of the configuration of the head part 12 of the liquid ejection device 100. The configuration illustrated in FIG. 5 can be considered as a modification of the configuration of the liquid ejection device. Except for the points described below, the liquid ejection device 100 may have features identical or similar to those of the shaping device 10 described with reference to FIGS. 1 to 4. For example, the liquid ejection device 100 may further have a configuration identical or similar to that of the shaping device 10 other than the illustrated configuration. In FIG. 5, configurations given the same reference signs as those in FIGS. 1 to 4 may have features identical or similar to those of the configurations in FIGS. 1 to 4.

The liquid ejection device 100 of this modification is a printing apparatus (inkjet printer) that performs printing by the inkjet method on a medium 60 (media) of a printing target, and includes the head part 12 and the main scan driving part 18. The head part 12 of this modification is a configuration that ejects ink for printing, and includes the ink ejection part 102 and a function unit 108. In this case, the ink can be considered as an example of the liquid ejected by the liquid ejection device 100. The ink ejection part 102 includes a carriage and a head unit similarly to the ink ejection part 102 of the shaping device 10 described with reference to FIGS. 1 to 4. In this case, the head unit can be considered as an example of an ejection head. The number of head units included in the ink ejection part 102 may be one or more. The carriage of the ink ejection part 102 can be considered as a carriage that holds the ejection head. The function unit 108 in this modification is an example of a function member, and is coupled to the carriage of the ink ejection part 102 by the coupling section 112 identically or similarly to the flattening roller unit 104 (see FIG. 1) of the shaping device 10. Also in this case, the coupling section 112 couples between the carriage of the ink ejection part 102 and the function unit 108 by the attraction force of the magnet, for example. The coupling section 112 may be a part of either the function unit 108 or the ink ejection part 102, and may have a configuration different from that of the function unit 108 and the ink ejection part 102. The coupling section 112 may couple between the carriage of the ink ejection part 102 and the function unit 108 other than the attraction force of the magnet.

Also in this modification, the main scan driving part 18 has a configuration identical or similar to that of the main scan driving part 18 of the shaping device 10 described with reference to FIGS. 1 to 4, and causes the head part 12 to perform the main scan operation. The function unit 108 is coupled to the carriage so as to move with this carriage at the time of the main scan operation outside this carriage of the ink ejection part 102. This configuration can appropriately move the function unit 108 together with the carriage at the time of the main scan operation with the function unit 108 being disposed outside the carriage of the ink ejection part 102. In this case, it becomes possible to achieve reduction in size and weight of the carriage of the ink ejection part 102 by disposing the function unit 108 outside the carriage of the ink ejection part 102.

In this case, it also becomes easy to perform attachment and removal of the function unit 108 by disposing the function unit 108 outside the carriage of the ink ejection part 102. It also becomes easy to use the function units 108 having various functions as necessary. Therefore, it is conceivable of using various members as the function unit 108 of this modification. As the function unit 108, it is conceivable of using, for example, a camera, a sensor, a cutter, a mist suction unit, a power unit for head traction, a shock absorbing device, a UV partition wall, or the like. In this case, it is conceivable of using at least one of these as the function unit 108. In a further modification of the configuration of the liquid ejection device 100, it is conceivable of coupling a plurality of the function units 108 to the carriage of the ink ejection part 102. In this case, the plurality of function units 108 having different functions from one another may be used.

Regarding an example of these function units 108, it is conceivable of using a camera (image quality checking camera) for checking the image quality of an image to be printed on the medium 60, for example, as the camera. As the sensor, it is conceivable of using, for example, a head gap sensor, a register mark detection sensor, a jam sensor, or the like. In this case, the head gap sensor can be considered as a sensor that detects a distance between the ejection head such as a head unit and an ink landing position. The register mark detecting sensor can be considered as a sensor for detecting a register mark, which is a position alignment mark drawn on the medium 60. The jam sensor can be considered as a sensor for detecting a jam that occurs at the time of conveying the medium 60. As the jam sensor, for example, a mechanical sensor, a photoelectric sensor, or the like can be suitably used.

As the cutter, for example, a cutting member for cutting at least a part of the medium 60 can be considered. As the cutter, for example, a cutter having a small movable range such as a V-cut cutter can be suitably used. This configuration can more appropriately exhibit the function of the cutter also when the cutter to be used as the function unit 108 is disposed outside the carriage of the ink ejection part 102. Unlike a cutter for a cutting plotter, such the cutter having a small movable range cannot change the cutting direction by 360 degrees, and can be considered as a cutter that obtains a cut surface with a small angle (e.g., about 15 degrees) by moving the head part 12 in the main scanning direction while conveying (feeding) the shaped object 50.

The mist suction unit can be considered as a configuration or the like that sucks the mist of ink generated by the ejection of ink by the ink ejection part 102, for example. The power unit for head traction can be considered as a configuration or the like that generates power for moving the ink ejection part 102 in the main scanning direction, for example. The power unit for head traction can be considered as a member or the like that functions as at least a part of the drive mechanism of the main scan driving part 18 when using the main scan driving part 18 having a configuration different from the configuration described in the above example with reference to FIGS. 1 to 4, for example. In this case, the function unit 108 as a power unit for head traction can also be considered to serve also as a part of the main scan driving part 18. Such the power unit for head traction can also be considered as a unit dedicated to driving force for moving the ink ejection part 102.

The shock absorbing device can be considered as a device or the like that absorbs an impact generated at the time of acceleration or deceleration of the head part 12 at the time of the main scan operation, for example. In a case of using a configuration having low durability against acceleration in the main scanning direction, such as an on-carriage cartridge (ink cartridge) and a resin structural member, it is conceivable of reducing the influence of the acceleration by coupling the function unit 108 as a shock absorbing device to the carriage of the ink ejection part 102. In this case, it is conceivable of using a unit or the like having a damper function, for example, as the shock absorbing device. The UV partition wall can be considered as a member or the like to be used in a countermeasure against stray light when an ultraviolet-curable ink is used as the ink, for example. As the UV partition wall, for example, a wall-shaped member or the like protruding in the Z direction with respect to the lower surface of the ink ejection part 102 can be suitably used. In this case, the Z direction can be considered as a direction orthogonal to the print surface of the medium 60. When an ultraviolet-curable ink is used as the ink, the head part 12 further includes an ultraviolet light source in addition to the function unit 108 used as the UV partition wall and the ink ejection part 102. In this case, it is conceivable of disposing the UV partition wall so as to separate a distance between the ejection head of the ink ejection part 102 and the ultraviolet light source. As the UV partition wall, for example, a member or the like whose lower surface is blackened can be suitably used.

Also when using such function unit 108, by disposing the function unit 108 outside the carriage of the ink ejection part 102 and coupling the function unit 108 to this carriage by the coupling section 112, it is possible to easily and appropriately perform adjustment and the like of the position of the function unit 108 while suppressing the influence on the adjustment and the like of the inclination of the carriage in the ink ejection part 102. Such ease of adjustment and the like can be considered as a particularly preferable feature when using the function unit 108 to be used while the ink is ejected by the ejection head of the ink ejection part 102. Such the function unit 108 can be considered as a configuration or the like to be used simultaneously with the ejection head of the ink ejection part 102 at the time of ejection of the liquid by the liquid ejection device 100. Such the function unit 108 can also be considered as a member or the like to be directly used for creation of a deliverable to be manufactured by the liquid ejection device 100. The member to be directly used for creation of a deliverable can be considered as a member or the like that performs an operation of changing the state of the deliverable being created in the main scan operation performed for creating the deliverable.

In relation to the configuration of the main scan driving part 18, the function unit 108 may have a feature identical or similar to that of the flattening roller unit 104 illustrated in FIG. 4, for example. More specifically, as illustrated in FIG. 4, when using the main scan driving part 18 including the guide rail 302 (see FIG. 4) and the belt 312 (see FIG. 4), it is conceivable of disposing the function unit 108 so as to be held by the guide rail 302 movably in the main scanning direction and not being directly connected to the belt 312. This configuration can appropriately move the function unit 108 together with the carriage of the ink ejection part 102 in the main scan operation while appropriately holding the function unit 108 by the guide rail 302.

The manner of disposing the function unit 108 may be different from that in the case of the flattening roller unit 104 illustrated in FIG. 4 in accordance with the function, size, and the like of the function unit 108. For example, when using the function unit 108 having a smaller weight than that of the flattening roller unit 104 of the shaping device 10 and the like, the carriage of the ink ejection part 102 and the function unit 108 may be coupled by the coupling section 112 in a state of not being directly connected to the belt 312 and not being held by the guide rail 302. When using the function unit 108 having a large weight, it is also conceivable of fixing the function unit 108 to the belt 312 of the main scan driving part 18. This configuration can more reliably move the function unit 108 at the time of the main scan operation also when the weight of the function unit 108 is large.

In the above example, regarding the configuration using the function unit 108 having a function different from that of the flattening roller unit 104, an example of the case of the liquid ejection device 100 as a printing apparatus that performs printing on the medium 60 has been mainly described. However, it is also conceivable of using the function unit 108 having a function different from that of the flattening roller unit 104 in the liquid ejection device 100 other than the printing apparatus. For example, it is also conceivable of using the function unit 108 having a function different from that of the flattening roller unit 104 in the shaping device 10.

### INDUSTRIAL APPLICABILITY

This invention can be suitably used for a liquid ejection device such as a shaping device.

### REFERENCE SIGNS LIST

10 Shaping device
100 Liquid ejection device
102 Ink ejection part
104 Flattening roller unit
106 Light source unit
10 Function unit
112 Coupling section
12 Head part
14 Shaping table
152 Light reflecting region
154 Colored region
16 Ink tank
18 Main scan driving part
20 Shaping table driving part
202 Carriage
204 Head unit
212 Nozzle row
22 Control part
302 Guide rail
304 Drive mechanism
306 Linear encoder
312 Belt
314 Driving pulley
316 Driven pulley
318 Motor
322 Linear scale
324 Sensor
402 Flattening roller
404 Motor
406 Motor
50 Shaped object
52 Support layer
60 Medium

1. A shaping device that shapes a shaped object by layering layers formed of a shaping material, the shaping device comprising:
an ejection head, configured to eject the shaping material;
a carriage, configured to hold the ejection head;
a main scan driving part, configured to cause the ejection head to perform a main scan operation of ejecting the shaping material while moving in a main scanning direction set in advance; and
a flattening member having a flattening roller, configured to flatten a layer formed of the shaping material,
wherein
the main scan driving part includes:
a guide member, configured to guide a movement of the carriage in the main scanning direction, and
a drive mechanism, configured to move the carriage along the guide member,
wherein the flattening member is held by the guide member movably in the main scanning direction outside the carriage, and is coupled to the carriage so as to move together with the carriage in the main scan operation.

2. The shaping device as set forth in claim 1, wherein
the drive mechanism includes: a belt member, having an annular shape stretched along a moving range of the carriage in the main scanning direction,
the drive mechanism is configured to move the carriage in the main scanning direction by rotationally moving the belt member,
the flattening member is configured to move in the main scan direction together with the carriage by not being directly connected to the belt member, being held by the guide member movably in the main scanning direction, and being coupled to the carriage.

3. The shaping device as set forth in claim 1, wherein
the flattening member is coupled to the carriage, so that a position of the flattening roller in a vertical direction is capable of being adjusted without changing an inclination of the carriage with respect to a horizontal direction.

4. The shaping device as set forth in claim 3, wherein
the flattening member is coupled to the carriage, so that the inclination of the carriage with respect to the horizontal direction is capable of being adjusted without changing the position of the flattening roller in the vertical direction.

5. The shaping device as set forth in claim 1, wherein
the flattening member is coupled to the carriage by being coupled to the carriage by an attraction force of a magnet.

6. The shaping device as set forth in claim 1, wherein
the flattening member further includes:
a rotation motor, configured to generate a driving force for rotating the flattening roller, and
a roller moving motor, configured to generate a driving force for moving the flattening roller in a vertical direction.

7. The shaping device as set forth in claim 1, wherein
the flattening member is disposed only on one side in the main scanning direction with respect to the carriage.

8. A shaping method of shaping a shaped object by layering layers formed of a shaping material, the shaping method using:
an ejection head, configured to eject the shaping material;
a carriage, configured to hold the ejection head; and
a flattening member having a flattening roller, configured to flattens a layer formed of the shaping material,
wherein
a main scan driving part causes the ejection head to perform a main scan operation of ejecting the shaping material while moving in a main scanning direction set in advance,
the main scan driving part includes:
a guide member, configured to guide a movement of the carriage in the main scanning direction, and
a drive mechanism, configured to move the carriage along the guide member,
wherein the flattening member is caused to be held by the guide member movably in the main scanning direction outside the carriage, and
the flattening member is coupled to the carriage so as to move together with the carriage in the main scan operation.

9. A liquid ejection device that ejects a liquid, comprising:
an ejection head, configured to eject the liquid;
a carriage, configured to hold the ejection head;
a main scan driving part, configured to cause the ejection head to perform a main scan operation of ejecting the liquid while moving in a main scanning direction set in advance; and
a function member that is a member having a predetermined function different from a function of the ejection head,
wherein
the function member is coupled to the carriage so as to move together with the carriage in the main scan operation outside the carriage.

10. (canceled)
